(19) United States
(12) Patent Application Publication
(10) Pub. No.: US 2008/0295315 A1
(43) Pub. Date: Dec. 4, 2008

(54) Method of making a metal frame

(76) Inventor: Chin-Hsing Horng, Taoyuan (TW)

Correspondence Address: Meng-Tsuey Pan, P.O. Box 1-252, Sanchung, 241, TW

(21) Appl. No.: 11/809,454

(22) Filed: Jun. 4, 2007

(51) Int. Cl. B23P 17/00

(52) U.S. Cl. 29/592

(57) ABSTRACT

A method of making a metal frame is a consistent operation including material-choosing, cutting, jointing, riveting and shaping, wherein the material-choosing is to take coiled banding metal plates as material and the metal plates are cut into two I-shaped and two flat U-shaped metal components. One piece or more than one pair of protrusions and indentions is correspondingly set on the ends of each metal component and each arm of the flat U-shaped metal components. Upon jointing, engage the protrusions and indentations on the I-shaped metal components with the corresponding protrusions and indentations on the edges of two arms. Upon riveting, the inner edge of each protrusion and the outer edge of each indentation are respectively punched to make stamping marks. Upon shaping, punch and fold rims of the metal frame to become roughly vertical for making a metal frame with inverted L-shaped cross-section on each side.

### BACKGROUND OF THE INVENTION

1. Field of the Invention

The present invention relates to a method of making a metal frame. Particularly, it relates to a manufacturing process which can not only save lots of material cost, but also simplify its making process. In addition, the method can assure the outer edges of the four angles of its finished product to be smooth and artistic in shape.

2. Description of the Related Art

In the inventor's prior Taiwan Patent No. I 253964 “Manufacturing method for a metal frame,” as a consequence of purely using coiled banding metal as its material, and consistent shaping operation with small-sized cutting, a considerable cost of material and cost for manufacturing the molds are saved when the metal frames are formed. However, after practical mass production and sales, we find that the inter-connecting position of the frame is located at the diagonal angles, so mending the angles is found to be rather inconvenient. Moreover, defects like failing to firmly hook up or the un-smoothness of the outer edges of the four angles will easily happen. Therefore, the inventor focused his attention to the studies of the present invention of “Method of making a metal frame.”

### SUMMARY OF THE INVENTION

The objective of the present invention is to provide an improved method of making a metal frame which can not only save costs of material and molds, but also simplify the making process. In addition, the method can assure the outer edges of the four angles on the metal frame to be smooth and artistic in shape after the finished product is made.

To realize the aforesaid objective, the method of making a metal frame herein is a consistent operation which comprises material-choosing, cutting, jointing, riveting and shaping, thereby manufacturing a big or giant square or rectangular metal frame with a cross-section in the form of roughly inverted L-shape.

First, the material-choosing step is to take coiled banding metal plates as material. Next, the cutting step is to punch the metal plates into two I-shaped metal components and two corresponding flat U-shaped metal components. One piece or one pair of arrow-shaped protrusions and indentations is punched respectively on two ends of the I-shaped metal components and the edges of two arms of the flat U-shaped metal components.

Upon jointing, embed and engage the protrusions and indentations on the two ends of said I-shaped metal components with protrusions and indentations on the edges of the two arms of the corresponding flat U-shaped metal components respectively.

Upon riveting, proceed with die stamping process around the inner edge of each protrusion and the outer edge of each indentation of each jointing region to make the periphery of each protrusion enlarged and the periphery of each indentation minified. As such, the metal frame will be jointed compactly as one integral unity.

As for the shaping step, the periphery of the metal frame is punched downward and folded vertically to make a big or giant square or rectangular metal frame having a cross-section in the form of roughly inverted L-shape.

Additionally, in the process of cutting, the metal components can be formed as two correspondingly long L-shaped metal components, and one piece or more than one pair of arrow-shaped protrusions and indentations is disposed on the edge of one arm and on the edge of the other arm respectively so as to make a big or giant rectangular metal frame with narrower width.

Furthermore, during the process of cutting, at least 3 pieces of wide V-shaped metal components are made, and one piece or more than one pair of arrow-shaped protrusions and indentations is disposed on the edge of each arm so as to make a big or giant polyhedral metal frame.

Each protrusion and indentation disposed on the end of each metal component, or on the edge or lateral edge of each arm can be modified into roughly wedge-shaped protrusion and indentation, or can be modified into roughly inverted U-shaped protrusion and indentation.

One piece or more than one pair of protrusions and indentations on the two ends of each metal component or the edge of each arm can be disposed as inclined position.

In other words, the method of making a metal frame of the present invention is to use a banding metal to form a pair of or more than two pieces of metal components embedded and engaged with each other to rivet as one integral unit. Then, punch and draw the metal unit to form a metal frame. The manufacturing process is a consistent operation, which includes material-choosing, cutting, jointing, riveting, and shaping, wherein said material-choosing process is to take coiled banding metal plates as material and then the metal plates are cut into two I-shaped and two flat U-shaped metal components or two correspondingly long L-shaped or at least more than three pieces of wide V-shaped metal components.

During the process of cutting, one piece or more than one pair of arrow-shaped, wedge-shaped or inverted U-shaped protrusions and indentions is correspondingly set on two ends of the two I-shaped metal components and the edges of two arms of the two flat U-shaped metal components, and on the edges or lateral edges of two arms of the two correspondingly long L-shaped or at least more than three pieces of wide V-shaped metal components.

Upon jointing, respectively embed and engage the protrusions and indentations on two ends of the two I-shaped metal components with the corresponding protrusions and indentations on the edges of two arms of the two flat U-shaped metal components, or with the corresponding protrusions and indentations on the edges or lateral edges of two arms of the two long L-shaped or at least more than three pieces of wide V-shaped metal components.

Upon riveting, the inner edge of each protrusion and the outer edge of each indentation on the jointing regions of said metal components are respectively punched to make the periphery of each protrusion enlarged and the inner edge of each indentation minified. As such, the metal frame will be jointed compactly as one integral unity and become a single-plate-made square, rectangular or polyhedral metal frame.

Upon shaping, punch and draw rims of the metal frame to become vertical or roughly vertical for making a big or giant square, rectangular or polyhedral metal frame with inverted L-shaped cross-section on each side.

One piece or more than one pair of protrusions and indentations on each metal component or each arm is set at a position of inclined angle.

### BRIEF DESCRIPTION OF THE DRAWINGS

FIG. 1 is a functional chart of manufacturing process of the present invention.

FIG. 2 is a plan view of the present invention concerning the process of preparing each and every metal component.

FIG. 3 is a plan view of the present invention concerning the embedding and engagement of each and every metal component with its corresponding component and a schematic view of the position where said components have been drawn to shape.

FIG. 4 is an enlarged schematic view of the riveting method of each and every jointing region of the present invention.

FIG. 5 is a vertical view of the metal frame of the present invention.

FIG. 6 is a lateral view of the present invention from the left side.

FIG. 7 is a lateral view of the present invention from the right side.

FIG. 8 is a plan view of the embedded and engaged metal components of the other preferred embodiment of the present invention.

FIG. 9 is a plan view of another embodiment of the present invention to show the protrusions and indentations of the jointing region on the metal component.

FIG. 10 is a plan view of the other embodiment of the present invention to show the protrusions and indentations of the jointing region on the metal component.

FIG. 11 is a plan view of embodiment with inclined angle of the jointing region on the metal component.

### DETAILED DESCRIPTION OF THE PREFERRED EMBODIMENT

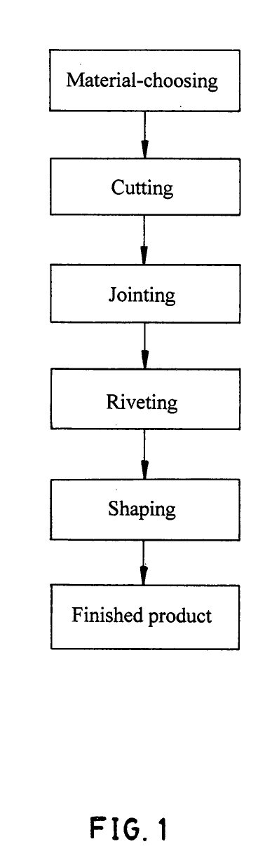

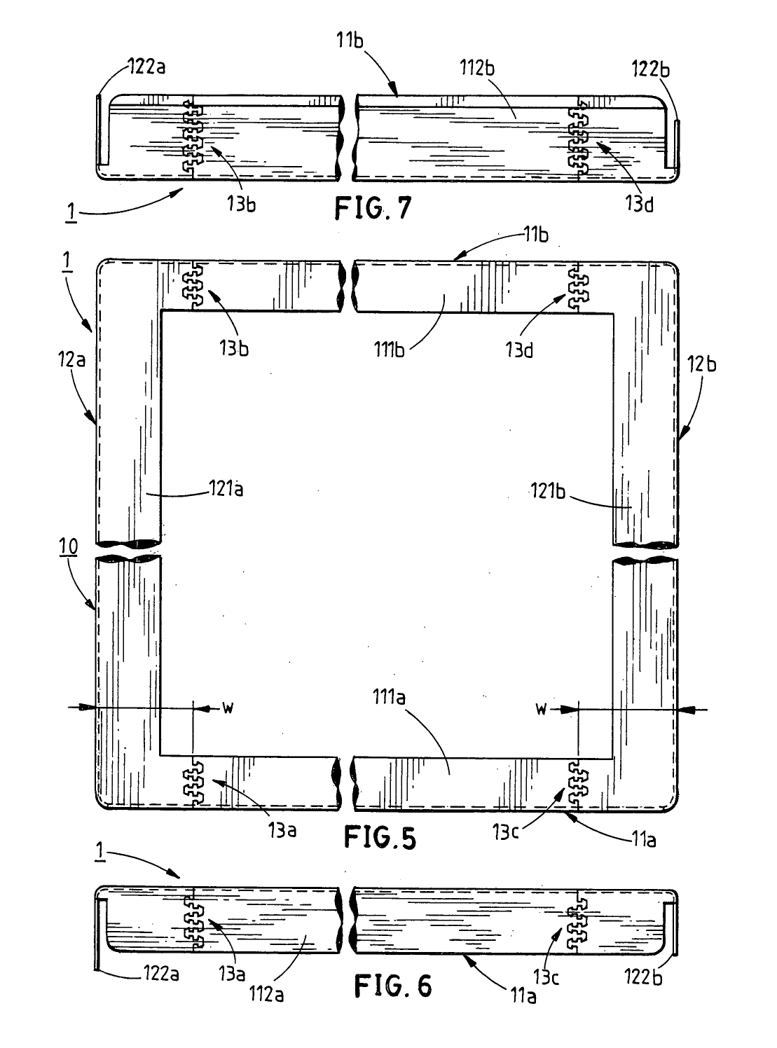

Referring to FIG. 1, a method of making a metal frame of the present invention is a consistent operation which mainly includes material-choosing, cutting, jointing, riveting, and shaping; it can make a big or giant square or rectangular metal frame 1 as a punching-and-drawing integral product, as shown in FIGS. 5, 6 and 7.

The manufacturing process of the square or rectangular metal frame 1 of the present invention is detailed as follows:

The initial procedure is material-choosing. First, take coiled banding metal plates as material, and the thickness of the metal plate depends on the size of the square or rectangular metal frame 1 (as shown in FIGS. 5, 6 and 7.) The width value of a left rim 11a and a right rim 11b is that the total width of left/right rim bodies 111a/111b and left/right lateral plate bodies 112a/112b minus the thickness of the metal plate serves as the basis for choosing the width of the first banding metal plate; the width value of an upper rim 12a and a lower rim 12b is that the total width of W (the width between the outer edge of upper/lower rim bodies 121a/121b and each jointing region 13a, 13b, 13c, 13d respectively, as illustrated in FIGS. 5, 6 and 7) and upper/lower lateral plate bodies 122a/122b minus the thickness of the metal plate serves as the basis for choosing the width of the second banding metal plate.

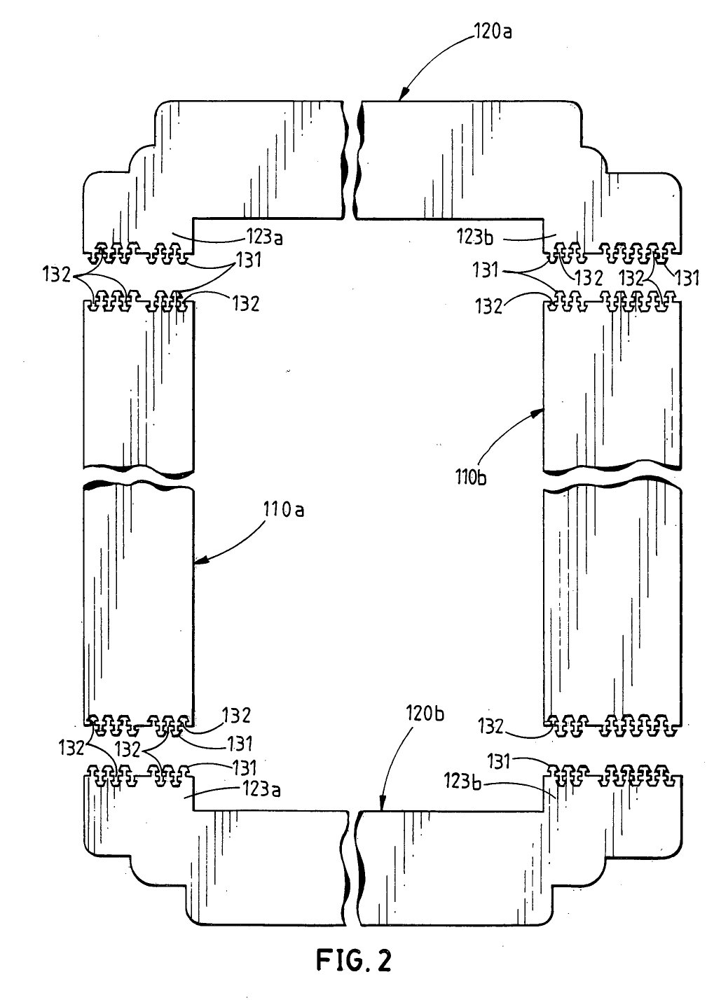

After the said two different widths of coiled banding metal plates have been chosen and prepared, lay them on two automatic cutting machines separately and they will be automatically delivered onto auto-punching machines. Proceed with auto-punching process on the metal plates via punching dies respectively. One of the auto-punching machines punches a left an a right I-shaped metal component 110a, 110b respectively, as shown in FIG. 2; the other punching machine punches two correspondingly upper and lower flat U-shaped metal components 120a and 120b, as shown in FIG. 2. When the punching process of said I-shaped metal components 110a, 110b and two flat U-shaped metal components 120a, 120b is being done, one piece or more than one pair of arrow-shaped protrusions 131 and indentations 132 is punched respectively on two ends of the I-shaped metal components 110a, 110b and the edges of two arms 123a, 123b of the corresponding flat U-shaped metal components 120a, 120b to make a connecting structure of each jointing region 13a, 13b, 13c, 13d of the square or rectangular metal frame 1 of the present invention, as illustrated in FIGS. 5, 6 and 7.

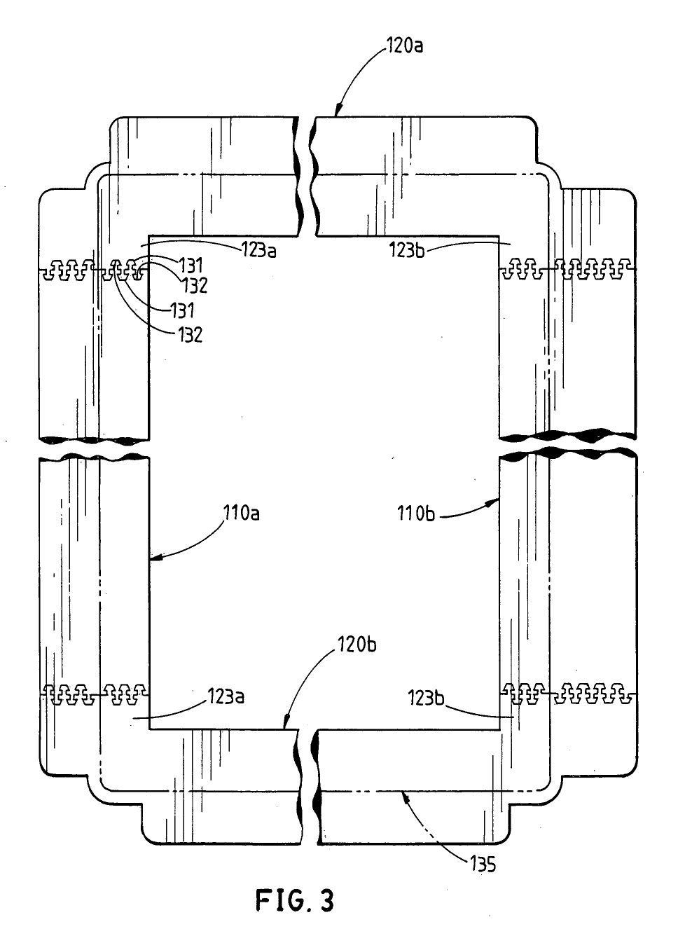

Upon jointing, as indicated in FIG. 3, embed and engage the protrusions 131 and indentations 132 on the upper and lower ends of said I-shaped metal components with protrusions 131 and indentations 132 on the edges of the two arms 123a, 123b of the corresponding flat U-shaped metal components 120a, 120b respectively to implement the work of embedding and engaging corresponding metal components with each other.

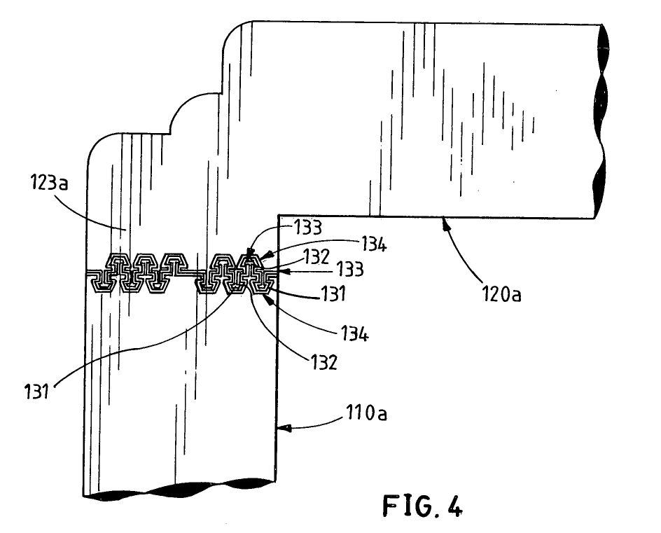

Upon riveting, as shown in FIG. 4, proceed with die stamping process around the inner edge of each protrusion 131 and the outer edge of each indentation 132 of said jointing regions to form stamping marks 133 and 134 so as to make the periphery of each protrusion 131 enlarged and the periphery of each indentation 132 minified. As such, the metal frame 1 will be jointed compactly as one integral unity and become a single-plate-made square or rectangular metal frame.

As for the final step of shaping, punch the periphery of said jointed metal frame of FIG. 3, by a punching or stamping machine or other similar machinery to punch or stamp downward and draw into vertical formation, on the position of imaginary square or rectangular frame line 135 to make a big or giant square or rectangular metal frame 1 having a cross-section in the form of roughly inverted L-shape.

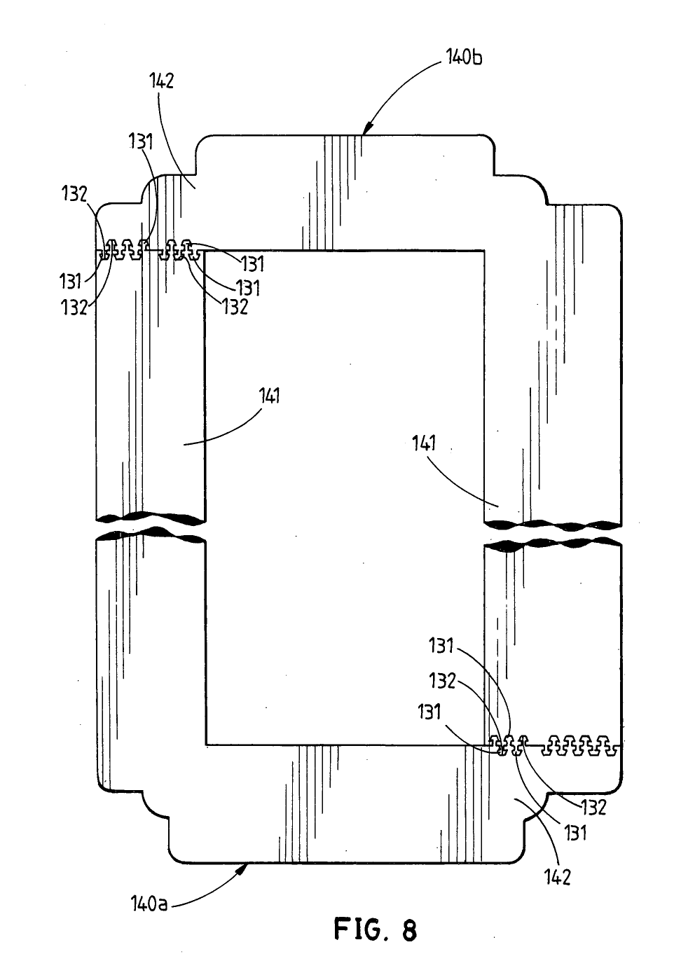

FIG. 8 is a schematic view of the other preferred embodiment of the present invention to show a big or giant metal frame with narrower width wherein the metal components are embedded and engaged with each other. In the process of cutting, two pieces of correspondingly long L-shaped metal components 140a, 140b are formed, and one piece or more than one pair of arrow-shaped protrusions 131 and indentations 132 is disposed on the edge of one arm 141 and the edge of the other arm 142 respectively. Then, follow the said processes of jointing, riveting and shaping to make another type of big or giant rectangular metal frame with narrower width. Likewise, in the process of cutting, at least 3 pieces of wide V-shaped metal components (omitted in the drawings) are made, and punched to set one piece or more than one pair of arrow-shaped protrusions and indentations on the edge of each arm. Then, follow the said processes of jointing, riveting and shaping to make a big or giant polyhedral metal frame.

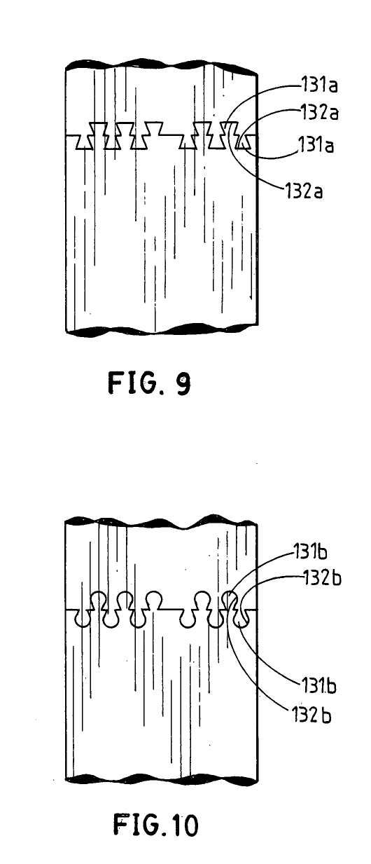

FIGS. 9 and 10 are schematic views of the other two different embodiments of the present invention concerning each protrusion and indentation on each jointing region. Each protrusion 131 and indentation 132 disposed on the end of each metal component, or on the edge or lateral edge of each arm can be modified into roughly wedge-shaped protrusion 131a and wedge-shaped indentation 132a (as shown in FIG. 9), or can be modified into roughly inverted U-shaped protrusion 131b and inverted U-shaped indentation 132b. The embedding, jointing and riveting processes are the same as the above-said processes, so there is no need to elaborate.

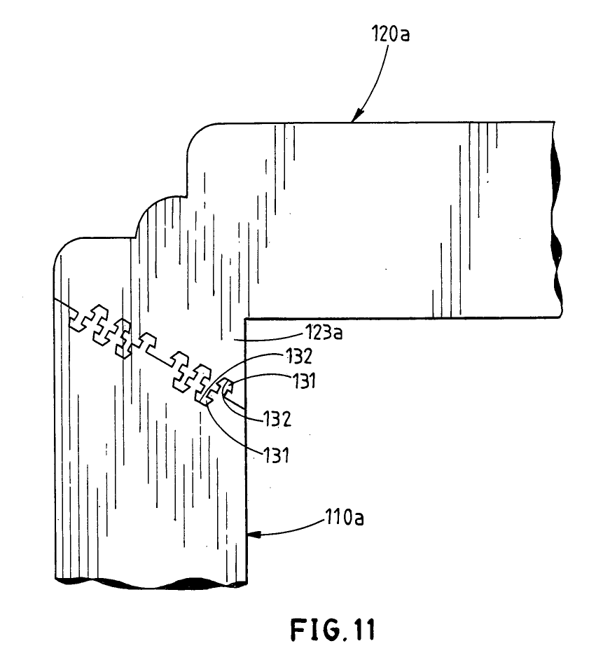

Moreover, FIG. 11 is a schematic view of another different embodiment of the present invention concerning the jointing region set on the two ends of each metal component or on the edge of each arm. Normally, the present invention sets one piece or more than one pair of protrusions and indentations on the two ends of each metal component or the edge of each arm, and the ends of each protrusion and indentation are vertical to each said metal component or each arm. However, an inclined position between the ends of protrusions 131 or indentations 132 and each said metal component 110a/120a or each arm 123a can be set as illustrated in FIG. 11, and the embedding and jointing processes and firmness are the same as the above-mentioned paragraph.

1. A method of making a metal frame using a consistent operation comprising material-choosing, cutting, jointing, riveting and shaping procedures to manufacture a big or giant square rectangular or polyhedral metal frame with a cross-section in the form of roughly inverted L-shape on each side thereof, wherein the material-choosing is to take coiled banding metal plates as material that is further characterized in:
the cutting procedure, using a cutter to cut the metal plates into two I-shaped metal components and two correspondingly flat U-shaped metal components, and one piece or one pair of arrow-shaped protrusions and indentations is punched respectively on two ends of the I-shaped metal components and the edges of two arms of the flat U-shaped metal components;
the jointing procedure by means of embedding and engaging the protrusions and indentations on the two ends of said I-shaped metal components with protrusions and indentations on the edges of the two arms of the corresponding flat U-shaped metal components respectively;
the riveting procedure, by means of punching or stamping around the inner edge of each protrusion and the outer edge of each indentation to make the periphery of each protrusion enlarged and the periphery of each indentation minified to thereby enable compact connection of each protrusion and indentation as one integral unity;
the shaping procedure, by means of downward-folding the periphery of the metal frame into vertically folded rim to make a big or giant square or rectangular metal frame having a cross-section in the form of roughly inverted L-shape.

2. The method of making a metal frame of claim 1 wherein the metal components, in the process of cutting, can be formed as two correspondingly long L-shaped metal components, and one piece or more than one pair of arrow-shaped protrusions and indentations is disposed on the edge of one arm and on the edge of the other arm of said L-shaped metal components respectively so as to make a big or giant rectangular metal frame with narrower width.

3. The method of making a metal frame of claim 1 wherein the metal components, in the process of cutting, can also be formed as at least 3 pieces of wide V-shaped metal components, and one piece or more than one pair of arrow-shaped protrusions and indentations is disposed on the edge of each arm of said V-shaped metal components so as to make a big or giant polyhedral metal frame.

4. The method of making a metal frame of claim 1, 2 and 3 wherein the protrusions and indentations can be modified into roughly wedge-shape, or into roughly inverted U-shape.

5. The method of making a metal frame of claim 1, 2 and 3 wherein the said one piece or more than one pair of protrusions and indentations on the two ends of each metal component or the edge of each arm thereof can be disposed at a position of inclined angle.
